(19) United States
(12) Patent Application Publication
(10) Pub. No.: US 2016/0213045 A1
(43) Pub. Date: Jul. 28, 2016

(54) Convection Product, Formula, and Method for Manufacturing

(71) Applicants: Madlen Gevorgian, Reseda, CA (US); Soseh Gevorgian, Reseda, CA (US)

(72) Inventors: Madlen Gevorgian, Reseda, CA (US); Soseh Gevorgian, Reseda, CA (US)

(21) Appl. No.: 14/607,795

(22) Filed: Jan. 28, 2015

(51) Int. Cl. A23L 1/36; A23L 1/00

(52) U.S. Cl. CPC A23L 1/362; A23L 1/0017; A23V 2002/00

(57) ABSTRACT

A confection food product and method for making a confection food product comprises a coconut sugar and coconut oil based binder, and nut and/or seed based ingredients.

### FIELD OF INVENTION

The present invention relates to convection goods, and methods for manufacturing of convection goods and snack-food products, and in particular to convection goods and snack food products (hereafter collectively referenced as “convection(s)”) made up typically of nuts combined with a sugar based binder.

### BACKGROUND ART

Existing methods for making snack-food products, such as convections, combine two basic ingredients, which include a binder, typically a sugar solution, and a dried component such as one or more nuts, which may or may not be accompanied by dried fruit or cereal. The process of manufacture, includes combining these ingredients, which are thoroughly mixed with heat and then formed and transferred into a drying oven. Whilst passing through or in the drying oven, moisture is removed from the sugar solution binder and also from the components of the snack-food product, resulting in dried, adhered components that can then be removed from the oven and packaged/distributed as snack food product.

To date, the existing methodologies have taught the use of cane sugar, high-fructose corn syrup, and similar sugars for use as a binder. Alternative binders have been contemplated and used (see patent nos.:) which are incorporated herein by referenced. However, the dietary attributes of existing sugar binders may be undesirable by some, and lead to digestive and/or dietary complications to others. Unfortunately, the use of substitute binders have not addressed these issues entirely, as the substitute binders lack the sweet and savory taste attributes of the traditional binders.

It is therefore an object of the present invention to provide a formula and method for manufacturing a convection or snack food product in which the binder is a healthy, flavorful alternative to conventional and existing binders. A further object of the present invention is to provide a formula and method for making a convection or snack food product in which there is reduced calories from sugars. An additional object of the present invention is to devise a convection or snack food product having a very low sugar content, which would make the convection much more acceptable for consumption by diabetics.

### DETAILED DESCRIPTION OF INVENTION

In accordance with the present invention, a formula and method of making a convection or snack food product is disclosed and comprises: Heating a convection binder above room temperature to achieve a liquid binder state: mixing ingredients for the convection or snack-food product with the liquid binder to obtain a formable mixture; and cooling the formable mixture to room temperature to form a convection or snack food product; wherein the binder comprising: brown rice syrup, coconut sugar and coconut oil; and the ingredients are selected from a group consisting of almonds, cashews, walnuts, sesame, pepita, alternatives thereof, and combinations therefrom.

Thus, the binder is in a liquid state at elevated temperature used for mixing of the product ingredients and sets when cooled, binding the ingredients for the product and setting to a relatively non-sticky and dry state suitable for the desired end product without further drying or processing steps. It is hence an advantage of the invention that the drying steps seen in the prior art methods are largely or wholly removed from the process of the present invention. The binder is typically selected from the group consisting of coconut syrup, coconut oil, brown sugar, maple syrup, salt, agave syrup, butter, derivatives thereof, and combinations therefrom. The ingredient are typically selected from the group consisting of almonds, cashews, walnuts, sesame, pepita, nuts, fruit, dried fruit, cereal products, cereal flakes, granola, extracts (e.g. vanilla, cardamom, nutmeg, cinnamon, etc.) and mixtures thereof, and preferably selected from the group consisting of almonds, cashews, walnuts, sesame, pepita, nuts, alternatives thereof, and combinations therefrom.

By elevated temperature it is intended to mean a temperature at which the binder is in a liquid state and is sufficiently liquid for snack food product ingredients to be mixed with the binder by conventional mixing equipment. The elevated temperature is preferably at least about 100° to 185° F., more preferably at least about 120° F. and even more preferably at least about 150° F. Generally, the binder and the ingredients are at substantially the same temperature during mixing, so that the binder remains liquid during mixing and does not set until the product precursor has been formed and then cooled.

The forming step optionally includes breaking or otherwise forming the mixture into a product precursor whilst at elevated temperature, or a ratio below elevated temperatures. Thus, the method may typically include cutting the heated mixture before it is completely cooled to set the binder. An advantage is that cutting the mixture whilst at elevated temperature tends to result in less waste product as the binder is still pliable.

In embodiments of the invention the binder is a sugar solution which is liquid at elevated temperature and which is set when cooled to below about room temperature. Room temperature is generally considerably below about 95 degrees F. and thus the binder advantageously sets so that in use binder will not risk melting in the hand of the consumer or in storage or in transit.

The sugar solutions used in preferred embodiments of the invention are characterized in that they have the properties set out above, namely that of being liquid at, or capable of being made liquid by heating to, elevated temperatures and setting when cooled to room temperature. The preferred sugar solutions include brown rice sugar, coconut sugar, coconut oil, and/or combinations thereof.

In a preferred embodiment of the invention described in more detail herein, the preferred confection food mixture is about 25% to 50% binder and 50% to 75% ingredients. Wherein a binder solution with about 75% to 90% sugars is found to give good results. The preferred binder also includes approximately 10% to 50% oil, preferably coconut oil.

The particular selection of sugar or sugars in the binder is considered essential to the invention, that is to say that particular sugar(s) must be included for the binder to operate. In addition, alternative sugars may be selected apart from the particular sugar(s), including edible monosaccharides and disaccharides consisting of maltose, saccharose, galactose, fructose and glucose, and mixtures thereof. Other components in trace amounts may also be included in the binder in accordance with the usual practice in this field, such as salts, extracts, preservatives, colorings and antioxidants.

A binder for use in the invention may be prepared by dissolving one or more sugars selected from the group consisting brown rice sugar, coconut sugar, and alternatives thereof, in water to form an aqueous sugar solution, and heating the solution to form a binder which is liquid at elevated temperature and which sets when it has been cooled to room temperature. The sugar solutions start to boil at about 235° F. or a little higher and can then be heated until the water content has been reduced to a point at which the boiling temperature is above about 225° F., preferably above about 220° F., and most preferably about 215-235° F. A binder solution of roughly 30% to 60% brown rice sugar, 20% to 50% coconut sugar, and 20% to 50% coconut oil is the preferred binder for the invention. It is further preferred all binder elements be organic.

The method of the invention is suitable for manufacture of snacks such as convections from ingredients such as almonds, cashews, walnuts, sesame, pepita, nuts, fruit, dried fruit, cereals, and cereal products. Particularly good results have been obtained in a method comprising, mixing coconut oil and syrup together at about a temperature of 200° F. or higher, and allowing the mixture to melt together. Followed by adding and mixing the coconut sugar and/or brown sugar to the melted coconut oil and syrup, under heat, until the entire mixture is mixing together and consists of a thick dark syrup consistency, known as the liquid binder. ingredients for the product are introduced to the liquid binder, under heat of approximately 200° F., to obtain a formable mixture. The ingredients and binder are preferably mixed at a temperature of 220° F. or higher, though not so high as to risk caramelization or burning of the binder. The mixture of binder and ingredients are continuously mixed by folding mixture upon itself. Mixing may occur for approximately five (5) to thirty-five (35) minutes, with folding occurring approximately every thirty (30) to one-hundred and twenty (120) seconds. Mixing may be carried out under heat, while the mixture is naturally cooled to room temperature, under external cooling, or any combination therefrom. The combined mixture is flattened and spread to approximately ten (10) millimeters to twenty (20) millimeters and allowed to thoroughly cool to room temperature. Upon adequate cooling, the mixture is broken up for packaging and weighed.

In a further embodiment of the invention, the method is for manufacture of snack bars, and the method comprises forming the heated mixture of ingredients plus binder into a sheet and cutting the sheet into snack bar forms, optionally via a combination of rotating knives and/or a guillotine. It is found in use of the embodiment of the invention that substantially no material is wasted, as the cutting process does not generate wasted fragments or other cuttings, and hence there is highly efficient use of the ingredients in producing the snack bars.

In a still further embodiment of the invention, the method is for manufacture of cookies, and comprises molding heated ingredients plus binder into cookie shapes, cooling the molds and thereafter releasing the cookies from the molds. Again, this process is found in use to generate no wastage of material.

A yet further aspect of the invention provides apparatus for making a convection or snack-food product, comprising: a mixing station, for mixing a binder solution with ingredients for the convection product; a forming station, for cooling and forming of a mixture of ingredients and binder into product precursors, said forming taking place at room temperature; a means for transferring the mixture from the mixing station to the forming station; and a packaging station for packaging the product into consumer ready packages for shipping and point of sale display.

Specific embodiments of the invention are now described in the following examples, detailing specific elements of the binder and ingredients, as well as detailed percentages of the binder and ingredients.

### Example 1

Organic Brown Rice Sugar—4.5 oz.

Organic Coconut Sugar—3.0 oz.

Organic Coconut Oil—1.5 oz.

Silvered and Blanched Almond—32 oz.

### Example 2

Organic Brown Rice Sugar—5.0 oz.

Organic Coconut Sugar—3.5 oz.

Organic Coconut Oil—3.5 oz.

Chopped Raw Cashews—32 oz.

### Example 3

Organic Brown Rice Sugar—4.5 oz.

Organic Coconut Sugar—4.75 oz.

Organic Coconut Oil—2.5 oz.

Raw Chopped Walnuts—32 oz.

### Example 4

Organic Brown Rice Sugar—4.5 oz.

Organic Coconut Sugar—4.0 oz.

Organic Coconut Oil—1.0 oz.

Roasted Pepitas—30 oz.

### Example 5

Organic Brown Rice Sugar—4.5 oz.

Organic Coconut Sugar—4.0 oz.

Organic Coconut Oil—4.0 oz.

Raw Shelled Sesame Seeds—30 oz.

### Example 6

Example 1—10.0 oz

Example 4—10.0 oz

Example 5—10.0 oz

1. A confection food comprising:
a binder; and
at least one ingredient,
wherein said binder is selected from a group consisting of coconut sugar, coconut oil, brown rice syrup, butter, alternatives thereof and combinations therefrom; and the ingredients are selected from a group consisting of almonds, cashews, walnuts, sesame, pepita, granola, extracts, alternatives thereof, and combinations therefrom.

2. The product of claim 1, wherein said binder is 25%-50% of total weight of the confection food.

3. The product of claim 1, wherein said at least one ingredient is 50%-75% of total weight of the confection food.

4. The product of claim 1, wherein said binder is 75%-90% sugar by weight, and 10%-25% oil by weight.

5. The product of claim 1, wherein said binder comprises coconut sugar and coconut oil.

6. The product of claim 1, wherein said binder comprises coconut sugar, coconut oil and brown rice sugar.

7. The product of claim 5, wherein said coconut sugar is 50%-80% of total weight of the binder, and coconut oil is 20%-50% of total weight of the binder.

8. The product of claim 1, further comprising a water-in-oil emulsion.

9. The product of claim 8, wherein said water-in-oil emulsion is 0.5%-5% total weight of the confection food.

10. The product of claim 1, further comprising a salt.

11. The product of claim 10, wherein said salt is 0.5%-5% total weight of the confection food.

12. A method for making a confection food product comprising the steps of:
providing a binder selected from a group consisting of coconut sugar, coconut oil, brown rice syrup, butter, alternatives thereof and combinations therefrom;
providing at least one ingredient selected from a group consisting of almonds, cashews, walnuts, sesame, pepita, granola, extracts, alternatives thereof, and combinations therefrom;
mixing the binder with the at least one ingredient to form a confection food product; and
setting the confection food product for packaging.

13. The method of claim 12, wherein the binder is heated between 180°-235° F. prior to mixing the binder with the at least one ingredient.

14. The method of claim 12, wherein the binder and at least one ingredient mixture is heated between 180°-235° F.

15. The method of claim 12, wherein the binder is 25%-50% of total weight of the confection food.

16. The method of claim 12, wherein said at least one ingredient is 50%-75% of total weight of the confection food.

17. The method of claim 12, wherein said binder is 75%-90% sugar by weight, and 10%-25% oil by weight.

18. The method of claim 12, further comprising adding a salt to the confection food.

19. The method of claim 12, further comprising adding a water-in-oil emulsion to the confection food.

20. The method of claims 13 and 14, further comprising cooling the confection food product prior to setting for packaging.
